(19) United States
(12) Patent Application Publication
(10) Pub. No.: US 2003/0192381 A1
(43) Pub. Date: Oct. 16, 2003

(54) Modular dynamometer can

(76) Inventors: Kirk E. Kelly, Downingtown, PA (US); John H. Crane, Coatesville, PA (US)

Correspondence Address: RATNERPRESTIA, P O BOX 980, VALLEY FORGE, PA, 19482-0980, US

(21) Appl. No.: 10/120,645

(22) Filed: Apr. 11, 2002

(51) Int. Cl. G01D 11/24; G01L 5/00; G01D 11/30

(52) U.S. Cl. 73/431; 73/862.541

(57) ABSTRACT

A modular dynamometer can assembly defining an interior region sized to house and support a dynamometer. The can assembly is formed from two modules: a main can form module and a separate and discrete motor end module. The main can form module is adapted for prefabrication at a first location and transportation in a disassembled state to a second installation location. Similarly, the motor end module is adapted for prefabrication at the first location and transportation in a disassembled state to the second installation location. The main can form module and the motor end module are assembled and engaged, forming the modular dynamometer can, at the second installation location.

### TECHNICAL FIELD

The present invention relates generally to dynamometers for simulating the inertia and road load forces encountered by motor vehicles under anticipated driving conditions and, more particularly, to a modular dynamometer can provided to facilitate the installation of a dynamometer in a pit formed in the cement floor of a service bay.

### BACKGROUND OF THE INVENTION

Dynamometers are often used in testing motor vehicles such as automobiles, trucks, motorcycles, and the like for which off-road operation is desired. Because the test vehicles are not moving over a road bed, the dynamometer must simulate certain forces normally associated with actual vehicle operation. These parameters include forces associated with inertial forces (related to the mass or weight of the vehicle) and road load forces (related to the velocity of the vehicle). The vehicle engine (or its braking system) must overcome inertial forces in order to accelerate or decelerate the vehicle. In addition, the engine must overcome breakaway frictional and rolling frictional forces (i.e., friction between the road and tires) as well as wind forces (i.e., drag forces caused by air passing over the vehicle). These latter forces are commonly referred to as road load forces.

The purpose of the dynamometer is to impose those forces on the vehicle which the vehicle would incur during actual operation on a road. Such dynamometers include a roll (or a pair of rolls) for engaging the driven wheel (e.g., motorcycle) or wheels (e.g., automobile) of the vehicle being tested. The roll or rolls are supported by a shaft journaled in bearings mounted on a frame. A typical dynamometer weighs about 1,800 pounds.

Many vehicle inspection and vehicle analysis procedures require placement of drive wheels of the vehicle on a dynamometer. A dynamometer allows the drive wheels of the vehicle to rotate while the vehicle remains stationary. Although the dynamometer is sometimes located on the floor of a service bay, the dynamometer more typically is located partially or entirely within a pit formed in the cement floor of the service bay so that the dynamometer is below the surface of the floor. The dynamometer is then installed within the pit in a manner which allows a vehicle to be driven off the floor and onto the dynamometer without requiring that the vehicle climb a ramp or otherwise perform a complex maneuver.

Surface bay floors are almost invariably made of cement. The cement used as the floor of a vehicle service bay or similar surface typically is formed from appropriate initial concrete materials, combined with water, and then poured in place before being allowed to harden into the desired final shape. The initial concrete materials typically include portland cement, sand, aggregate, lime, and water. When liquid, the concrete material can easily be poured into forms which remain in place until the material hardens. The forms are then removed and the desired finished contour remains for the cement floor.

Hence, when a pit is desired in the floor of a vehicle service bay, an area is initially excavated surrounding the location where the pit will be located. Forms are then put in place where the pit is desired to prevent the liquid concrete material from filling up the pit when poured. Before the concrete is poured, it is desirable that steel reinforcing bar, called “rebar,” be oriented strategically below the surface for the cement material and surrounding the pit region. The rebar significantly enhances the strength of the cement and allows the cement to more effectively support the weight of vehicle wheels in the area surrounding the dynamometer pit. Once the rebar is in place, the concrete material is poured up to the desired level for the surface. The cement is then allowed to harden by evaporation of the water from the cement material. Finally, the forms are removed so that the pit remains.

U.S. Pat. No. 6,152,652 issued to Mosby describes an apparatus and method for installing a dynamometer pit in cementitious material. During prosecution of the application which issued as the '652 patent, Mosby disclosed a concrete spreader-form manufactured by Spec-West of Rancho Cordova, Calif. and delivered to Mosby Construction, Inc. Engineering drawings of this spreader-form are dated Apr. 19, 1997. Mosby described the product as follows:

This spreader/form includes a planar rectangular floor with four planar rectangular walls (the two end walls are nearly square) which hingedly attach to the floor. A spreader bar extends between the two side walls which attach to the longest edges of the floor. This spreader bar can be adjustably positioned to support and space the two side walls away from each other. Mounting bars support this entire spreader/form in position before the concrete is poured. Concrete is then poured around this spreader/form. The cementitious material is allowed to harden. Finally, the spreader bar is released so that the side walls can fold down toward the floor and the end walls can fold down toward the floor so that the spreader/form can be removed from the cementitious material. A hole remains into which a dynamometer can be installed and the spreader/form can be reused at another construction site.

Although the conventional process of forming a pit within a surface of cement is generally effective, it suffers from a variety of drawbacks. The process of properly orienting the rebar and positioning the temporary forms (such as the spreader-form manufactured by Spec-West) in place to form the pit can be particularly time consuming. If the forms are not properly spaced relative to the rebar, the strength of the cement is degraded. In addition, the forms cannot be removed until the cement material hardens. Therefore, installers of the pit must make at least two trips to the construction site: one trip to set up the rebar and forms and pour the concrete, and a second trip to remove the forms after the cement material has properly hardened.

Further, the surfaces of the pit are formed by the cement adjacent the forms. Although cement exhibits sufficient strength characteristics in compression, it is susceptible to cracking and failure in tension loads. Therefore, cement is necessarily not the most desirable material for forming walls of the pit in which the dynamometer is located. Because cement is not the best material for forming the walls of the pit, steel cans are often used to line the cement pit, forming the walls for the dynamometer pit. Preferably, the can is cemented into the floor of the bay.

In the '652 patent, Mosby describes a pit assembly which includes a steel can (or “pan”) that acts as a surface liner for a dynamometer pit and which includes a rebar cage affixed to the pan. The rebar cage is properly spaced from the pan to provide the required reinforcement of the cement surrounding the pan. This pit assembly is placed at the desired location and in the desired orientation for the dynamometer pit. Cement material is then ready to be poured around the pit in a manner surrounding and covering the rebar cage of the pit assembly and coming into contact with outer surfaces of the pan. The interior of the pit assembly remains open. After the cement material has hardened, the dynamometer pit is completely formed. No portion of the pit assembly needs to be removed after the cement has hardened.

The pan described by Mosby has a number of drawbacks. First, the extensive rebar cage complicates the manufacturing process and adds significant cost to the product. This drawback is exacerbated because the rebar cage is unnecessary, for at least some applications, rendering its inclusion as part of the pan overkill. Second, the rebar cage adds weight to and increases the outer dimensions of the pan. Third, the pan is designed to be prefabricated at a first location and then transported to a second location, such as a vehicle service bay, where the pan is installed. Transportation of the rather bulky pan is relatively difficult and expensive.

To overcome the shortcomings of conventional dynamometer cans used to facilitate the installation of a dynamometer in a pit formed in the cement floor of a service bay, a new modular dynamometer can is provided. An object of the present invention is to provide an improved dynamometer can that is formed from separate, discrete modules each of which is itself formed from separate components. A related object of the present invention is to provide a dynamometer can which is capable of being prefabricated at a first location and then transported in separate pieces to a second installation location, such as a vehicle service bay. Another object is to facilitate transportation, both before and after assembly, of the dynamometer can. A dynamometer can having minimal weight and outer dimensions is a further object of the present invention.

It is still another object of the present invention to provide an assembly which can form a pit in a surface of cement material without requiring the installation and removal of temporary forms. An additional object is to separate the functions of a liner for the pit from any rebar desired for reinforcement of the cement material surrounding the pit, thereby avoiding the need for orienting the rebar simultaneously with placing the liner. Yet another object of the present invention is to provide a dynamometer can that forms a liner for the pit receiving a dynamometer.

Another object of the present invention is to provide a dynamometer can that includes a sump region facilitating the removal of unwanted liquids which might collect within the can. It is another object of the present invention to provide a dynamometer can sized to receive a dynamometer and at least some of the equipment associated with the operation of the dynamometer. Overriding objects of the present invention are to simplify the manufacturing process for and to minimize the cost of a dynamometer can.

### SUMMARY OF THE INVENTION

To achieve these and other objects, and in view of its purposes, the present invention provides a modular dynamometer can assembly defining an interior region sized to house and support a dynamometer. The can assembly is formed from two modules: a main can form module and a separate and discrete motor end module. The main can form module is adapted for prefabrication at a first location and transportation in a disassembled state to a second installation location. Similarly, the motor end module is adapted for prefabrication at the first location and transportation in a disassembled state to the second installation location. The main can form module and the motor end module are assembled and engaged, forming the modular dynamometer can, at the second installation location.

More specifically, the main can form module is assembled from at least the following individual components: (a) a first side wall having a lip with a plurality of holes, (b) a second side wall disposed opposite the first side wall and having a lip with a plurality of holes, (c) a sloped floor located between the first and second side walls and having a ledge adapted to support the dynamometer with anchor holes in the ledge accommodating projections on the dynamometer, and (d) an end wall engaging the first side wall, the second side wall, and the floor, closing one end of the main can form module when the main can form module is assembled, extending below the floor, including a platform, and having a pair of fork slots adapted to engage the prongs of a fork lift. The separate motor end module defines a sump region facilitating removal of any liquids that collect in the can and is assembled from at least the following individual components: (a) a U-shaped center including two opposing side walls and a bottom, the opposing side walls each having a flange with at least one hole, (b) an access wall closing one end of the center when the motor end module is assembled, extending below the bottom, including a shoulder, and having at least one opening adapted to receive conduits serving the dynamometer and a pair of fork slots adapted to engage the prongs of a fork lift, and (c) an intermediate wall closing the second end of the center when the motor end module is assembled and having a cutout engaging the main can form module when the main can form module and the motor end module are assembled.

Angles are provided on the first side wall, the second side wall, the floor, and the U-shaped center connecting the components and reinforcing the stiffness and rigidity of the can when assembled. To facilitate attachment of the can to the cement that typically surrounds the can, a plurality of bolts are received in the holes of the lips of the first and second side walls and in the holes of the flanges of the opposing side walls. The platform of the end wall, the shoulder of the access wall, the lips of the first and second side walls, and the flanges of the opposing side walls are all disposed in substantially the same horizontal plane creating a neck around the upper periphery of the can when the modules are assembled. The neck engages the edges of the cement pit so that the can seats within and lines the pit and is supported, in part, by the engagement between the neck and pit edges.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a perspective view of one module, the main can form, used to construct the dynamometer can according to the present invention;

FIG. 2 is a perspective view of a first embodiment of the second module, the motor end, used to construct the dynamometer can according to the present invention;

FIG. 3 is a perspective view of a second embodiment of the second module, the motor end, used to construct the dynamometer can according to the present invention;

FIG. 4 is a top plan view of the assembled dynamometer can, including the first embodiment of the motor end module illustrated in FIG. 2, according to the present invention;

FIG. 5 is a front view of the assembled dynamometer can illustrated in FIG. 4;

FIG. 6 is a bottom plan view of the assembled dynamometer can illustrated in FIG. 4;

FIG. 7 is a left side view of the assembled dynamometer can illustrated in FIG. 4;

FIG. 8 is a right side view of the assembled dynamometer can illustrated in FIG. 4; and

FIG. 9 is a perspective view of the assembled dynamometer can, according to the present invention, seated within a cement dynamometer pit.

### DETAILED DESCRIPTION OF THE INVENTION

Referring now to the drawing, in which like reference numbers refer to like elements throughout the various figures that comprise the drawing, the dynamometer can 10 of the present invention has a rectangular shape formed from two, separate modules. The first module 20 comprises a main can form; the second module 60 comprises a motor end. Modules 20, 60 engage (i.e., are bolted together) to complete can 10. Two, separate motor end modules 60 are provided which differ in size only: deep and shallow versions.

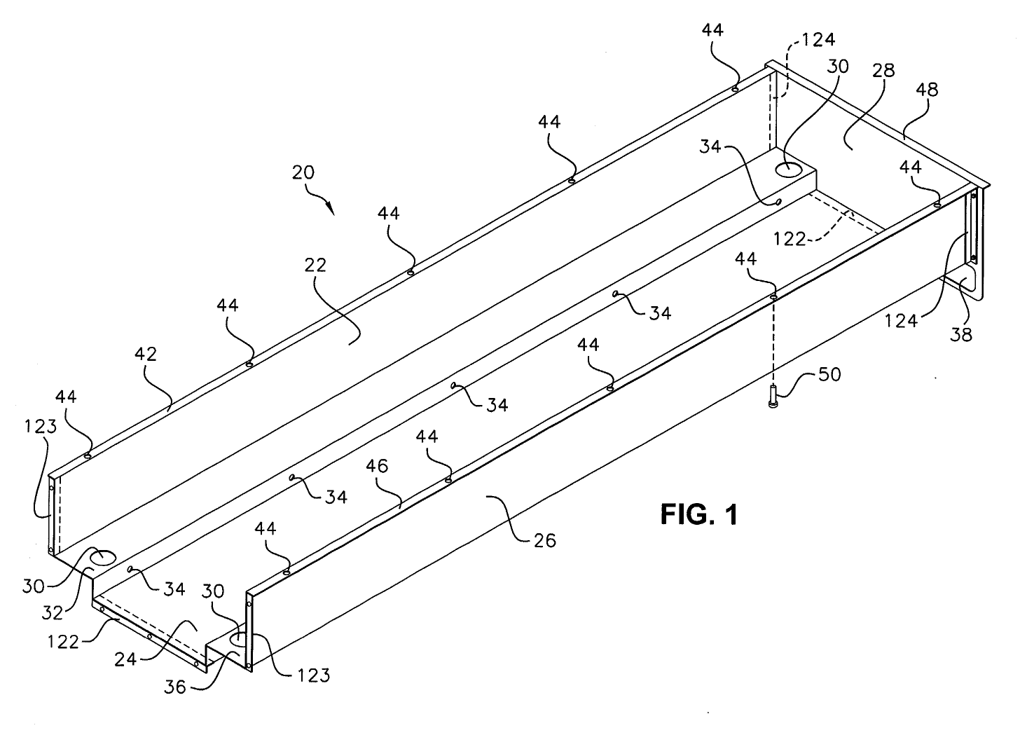

Turning first to main can form module 20, illustrated in FIG. 1, that first module is formed from four, separate components. A first side wall 22, a second side wall 26, a floor 24, and an end wall 28 are attached (i.e., bolted) together to assemble main can form module 20. Each side wall 22, 26 is bent near its bottom to form a horizontal ledge 32 and 36, respectively, located adjacent floor 24. A plurality of anchor holes 30 (typically three or four) are provided in ledges 32, 36 to accommodate projections on the dynamometer, enabling the dynamometer to be affixed directly to the concrete underlying can 10. Each side wall 22, 26 is bent near its top to form a lip 42 and 46, respectively, having a plurality of holes 44 (five are shown). Holes 44 receive bolts 50 used to anchor can 10 to the surrounding cement.

End wall 28 extends below floor 24 to accommodate a pair of fork slots 38 adapted to receive the prongs of a fork lift to facilitate transportation of main can form module 20, fully assembled can 10, or both. Three angles 124, 124, 122 are tacked one each respectively to first side wall 22, second side wall 26, and floor 24 of main can form module 20 and are used to bolt end wall 28 to first side wall 22, second side wall 26, and floor 24. The angles are preferably tacked by welding them to main can form module 20 to facilitate both shipping to (i.e., the angles are not loose) and assembly at the service bay site.

End wall 28 is bent near its top to form a platform 48. Because end wall 28 is much shorter than side walls 22, 26 and has less tendency to buckle, it is not necessary to bolt end wall 28 to the surrounding cement; therefore, no holes need be provided in platform 48. If desired, however, platform 48 could be provided with holes to receive additional bolts 50 used to anchor end wall 28 of can 10 to the surrounding cement.

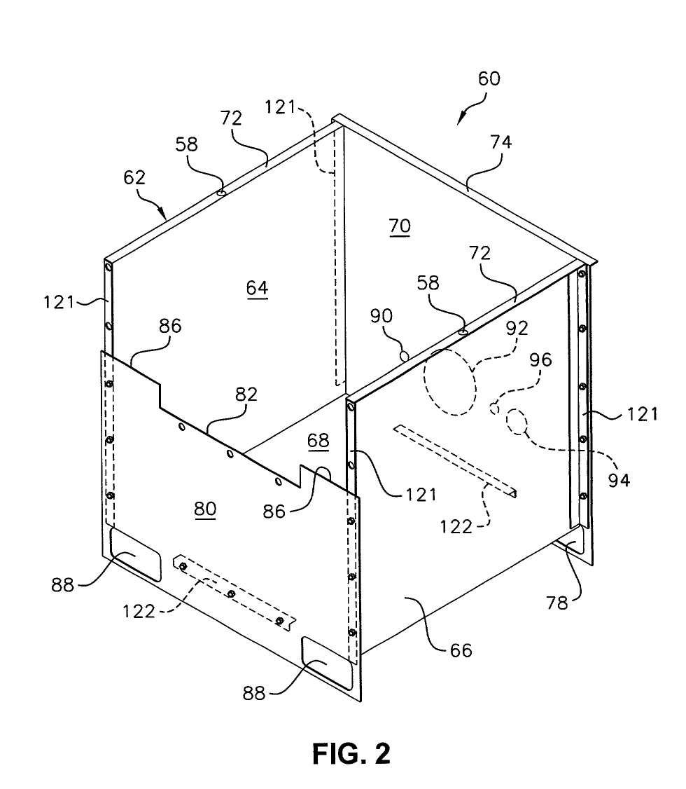

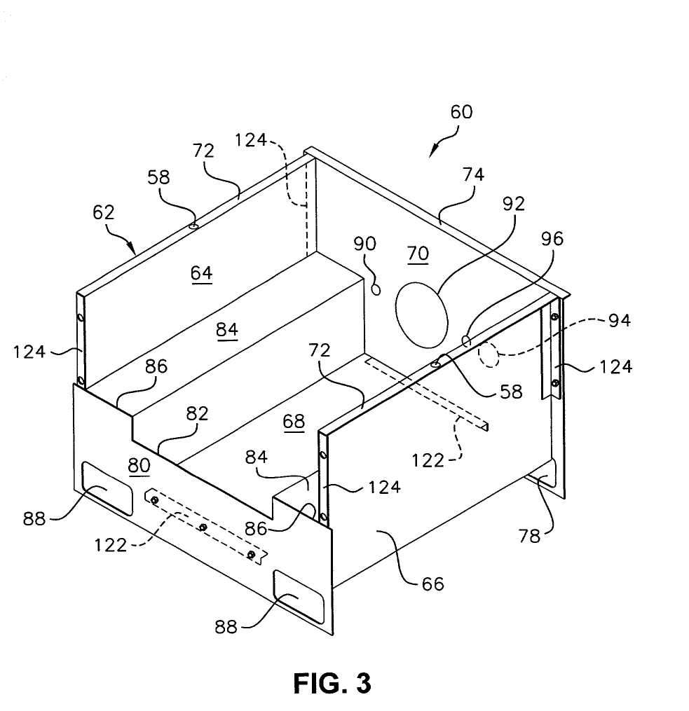

FIG. 2 is a perspective view of a first (deep) embodiment of motor end module 60; FIG. 3 is a perspective view of a second (shallow) embodiment of motor end module 60. For either embodiment, motor end module 60 is essentially a box formed by three components: a U-shaped center 62, an access wall 70, and an intermediate wall 80. U-shaped center 62 comprises two parallel and opposite side walls 64, 66 and a bottom 68. Bolted to center 62 using six angles are access wall 70 and intermediate wall 80. Three angles 121, 121, 122 are provided (one each on side wall 64, side wall 66, and bottom 68) near one open end of center 62 to attach access wall 70. Similarly, three angles 121, 121, 122 are provided (one each on side wall 64, side wall 66, and bottom 68) near the opposite open end of center 62 to attach intermediate wall 80. The angles are preferably tacked by welding them to center 62 to facilitate both shipping to and assembly at the service bay site. Side walls 64, 66 are each bent near their top to form a flange 72 having at least one hole 58. Holes 58 in flanges 72 receive bolts 50 used to anchor can 10 to the surrounding cement.

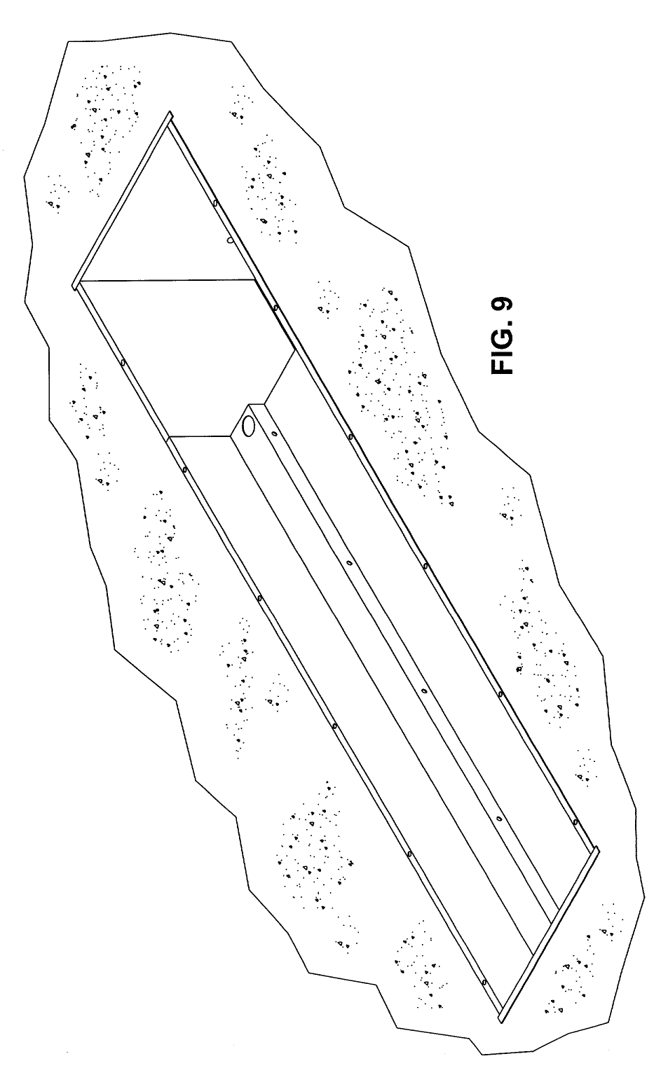

Access wall 70 extends below bottom 68 to accommodate a pair of fork slots 78 adapted to receive the prongs of a fork lift to facilitate transportation of motor end module 60, fully assembled can 10, or both. Dynamometers require a source of clean, dry, compressed air at 100 to 150 psi and have AC power requirements. Therefore, as best illustrated in FIG. 8, access wall 70 has a number of openings though which conduits may pass. Four openings are illustrated: the smallest opening 90 (about one inch in diameter) allows passage of an electrical cable to meet the dynamometer power requirements; the largest opening 92 (about 6.5 inches in diameter) allows passage of a ventilation outlet line; the intermediate opening 94 (about 2.5 inches in diameter) allows passage of an air line; and one or more additional openings 96 optionally may be provided to allow passage of other conduits.

Access wall 70 is bent near its top to form a shoulder 74. Because access wall 70 is much shorter than side walls 22, 26 and has less tendency to buckle, it is not necessary to bolt access wall 70 to the surrounding cement; therefore, no holes need be provided in shoulder 74. If desired, however, shoulder 74 could be provided with holes to receive additional bolts 50 used to anchor access wall 70 of can 10 to the surrounding cement.

Intermediate wall 80 has a cutout 82 for engaging the open end of main can form module 20 and, specifically, floor 24 of main can form module 20. Ledges 32 and 36 of main can form module 20 engage the top 86 of intermediate wall 80 on opposite sides of cutout 82. Intermediate wall 80 extends below bottom 68 to accommodate a pair of fork slots 88, adapted to receive the prongs of a fork lift to facilitate transportation of motor end module 60, fully assembled can 10, or both. The distance between top 86 of intermediate wall 80 and flanges 72 of side walls 64, 66 of center 62 is substantially the same as the height of side walls 22, 26 between ledges 32, 36 and lips 42, 46. Thus, flanges 72 of side walls 64, 66 lie in substantially the same horizontal plane as lips 42, 46 of side walls 22, 26 once can 10 is fully assembled and installed.

The main difference between the two (deep illustrated in FIG. 2 and shallow illustrated in FIG. 3) embodiments of motor end module 60 is that bottom 68 of motor end module 60 is substantially flush with (i.e., lies in substantially the same horizontal plane as) floor 24 of main can form module 20 in the shallow embodiment but is located well below floor 24 in the deep embodiment. This difference is achieved by shortening the lengths of (1) sides 64, 66 of U-shaped center 62, (2) access wall 70, and (3) intermediate wall 80 for the shallow embodiment relative to the deep embodiment. A pair of steps 84 may optionally be provided for the shallow embodiment. Steps 84 are sized to seat inside motor end module 60 on bottom 68 and adjacent side walls 64, 66, extending from access wall 70 to intermediate wall 80 and from bottom 68 to tops 86 of intermediate wall 80. So sized, steps 84 and ledges 32, 36 of main can form module 20 create a base in a single horizontal plane upon which the dynamometer can rest when can 10 is fully assembled. Steps 84 may be tacked (i.e., welded) to bottom 68, respective side walls 64 and 66, or both.

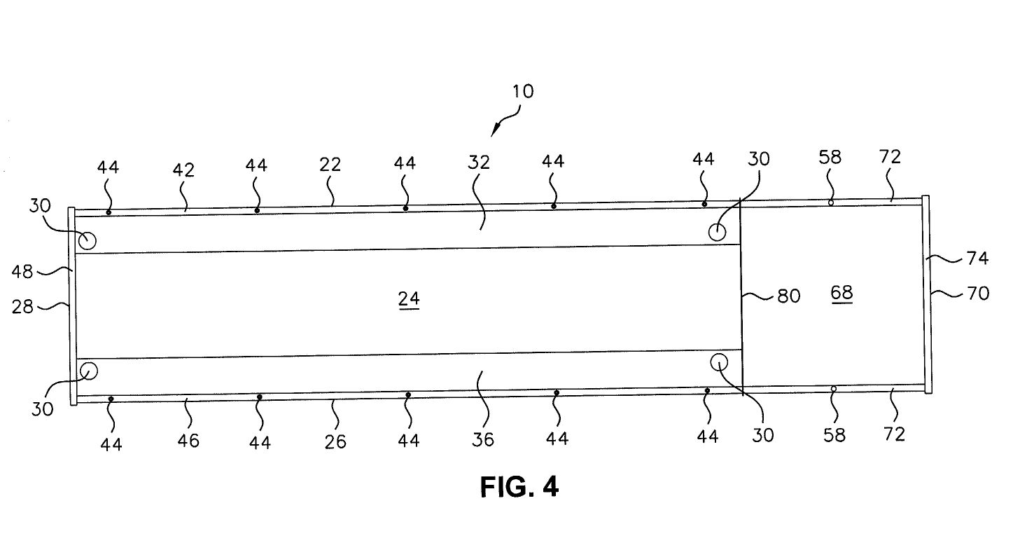

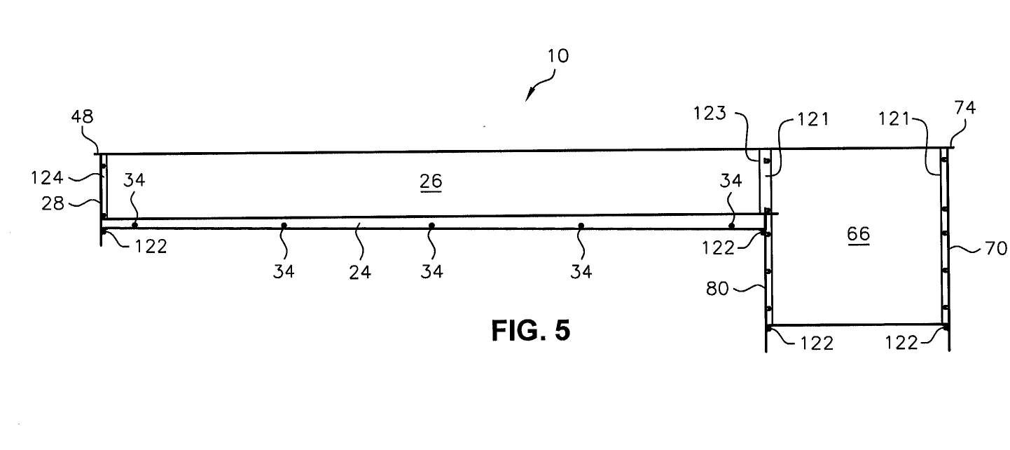

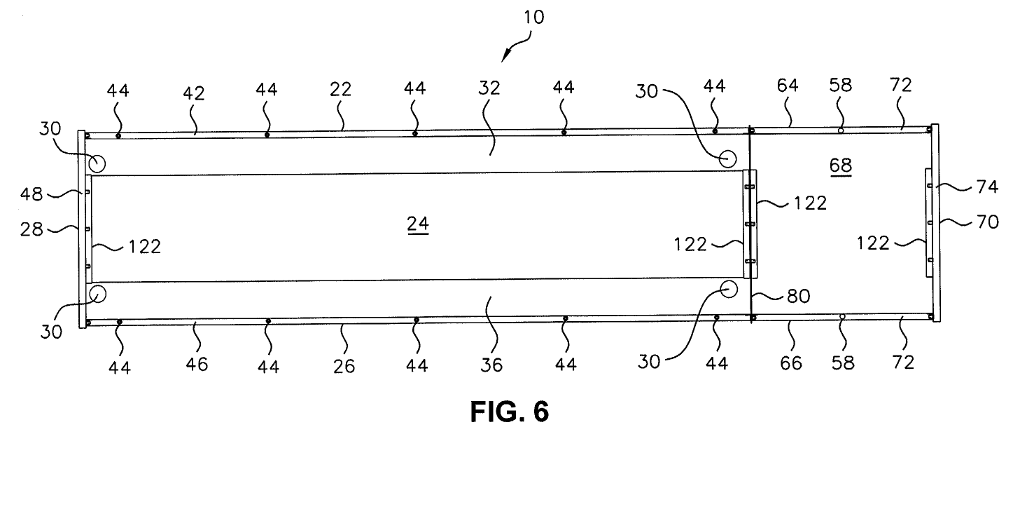

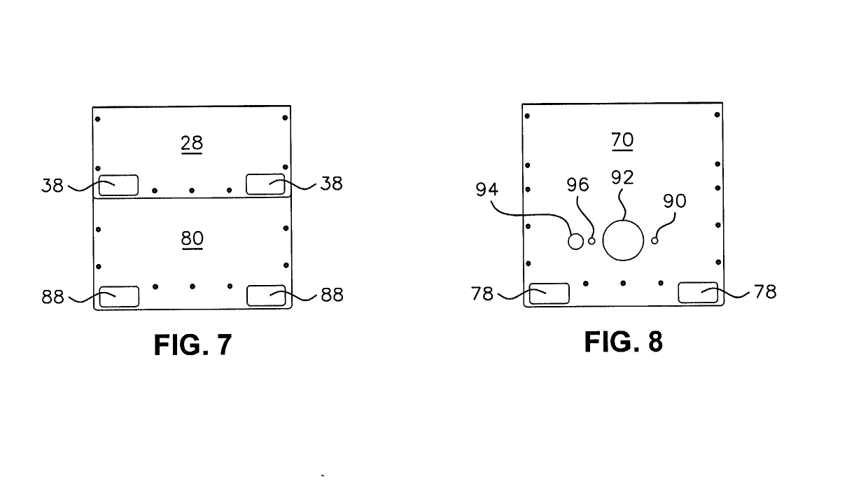

A total of twelve angles are provided, three for each of the two ends on main can form module 20 and on motor end module 60. Each angle has a plurality of holes into which are placed integral inserts which receive corresponding bolts (0.313 inch bolts are suitable). The angles with their inserts and bolts are used to assemble the components of modular can 10. FIG. 4 is a top plan view of fully assembled dynamometer can 10, including the first (deep) embodiment of motor end module 60 illustrated in FIG. 2, according to the present invention. FIGS. 5, 6, 7, and 8 are a front view, a bottom plan view, a left side view, and a right side view, respectively, of assembled can 10 illustrated by the top plan view of FIG. 4.

Can 10 is formed from rigid steel, having characteristics that are selected to provide the desired strength and corrosion properties to be effective in the dynamometer pit environment. Twelve-gauge steel is preferred. The stiffness and rigidity of can 10 are reinforced by angles 121, 122, 123, 124 and by lips 42 and 46, platform 48, shoulder 74, and flanges 72 which, in part through bolts 50, engage the cement surrounding can 10. Bolts 50 anchor can 10 to the surrounding cement and stiffening angles 121, 122, 123, 124 connect the components of can 10 and reinforce the walls of can 10 by adding stiffness and rigidity to those walls.

Platform 48 on end wall 28 of main can form module 20; lips 42, 46 on side walls 22, 26, respectively, of main can form module 20; flanges 72 on side walls 64, 66 of motor end module 60; and shoulder 74 of access wall 70 of motor end module 60—all combine to create a uniform neck around the upper periphery of can 10. The neck created by platform 48, lips 42 and 46, flanges 72, and shoulder 74 allows can 10 to seat in the dynamometer pit formed in the cement floor of the service bay with can 10 flush or level with that floor. More specifically, the neck engages the edge of the pit, resting on top of the floor. The remainder of can 10 hangs down into and lines the pit.

The neck provides an overhang of about one inch around can 10. The holes in the various components that form the neck receive inserts which, in turn, receive bolts 50. The neck displaces bolts 50 away from the body of can 10, allowing cement to be poured around bolts 50 and adjacent the body of can 10. Thus, bolts 50 anchor can 10 to the cement.

As described above, end wall 28 of main can form module 20 extends below floor 24 to accommodate a pair of fork slots 38. Access wall 70 of motor end module 60 extends below bottom 68 to accommodate a pair of fork slots 78, and intermediate wall 80 of motor end module 60 extends below bottom 68 to accommodate a pair of fork slots 88. Fork slots 38, 78, and 88 are all adapted to receive the prongs of a fork lift to facilitate transportation of modules 20 and 60, of fully assembled can 10, or both. The fork lift operator has various options to lift can 10 from either end and with can 10 upright or upside down. Although fewer or a greater number of fork slots may be provided on can 10, six fork slots are illustrated for purposes of example only: two fork slots 38 on main can form module 20 and four fork slots 78, 88 on motor end module 60.

Can 10 has an open top and defines an interior region sized to house the dynamometer. Floor 24 of can 10 is preferably at least partially sloped so that any liquids within can 10 migrate to the sump created by motor end module 60. The sump provides a convenient location for liquids which might collect within can 10 and from which the liquids can be removed, if desired, by a pump. It is not necessary to provide can 10 with any rebar.

Can 10 typically is used to facilitate the installation of a dynamometer in a pit formed in the cement floor of a service bay. For at least some applications, however, can 10 may house the dynamometer either entirely or partially above ground level. Can 10 is formed from separate, discrete modules 20, 60—as described above in detail—each of which is itself formed from separate components. The components are capable of being prefabricated at a first location and then transported in separate pieces (either as individual components entirely unassembled or as partially assembled modules 20, 60) to a second installation location, such as a vehicle service bay. Thus, transportation before assembly of can 10 is facilitated, the manufacturing process for can 10 is simplified, and the cost of manufacturing and transporting can 10 is minimized.

Can 10 is sized to receive a dynamometer and at least some of the equipment associated with the operation of the dynamometer. The weight and outer dimensions of can 10 are minimized, however, while maintaining functionality. In addition, fork slots 38, 78, and 88 are provided for easy and secure engagement of modules 20, 60 and of fully assembled can 10 by the prongs of a fork lift. Thus, transportation during and after assembly of can 10 is facilitated.

Once assembled and positioned at the installation site, can 10 may be used to form a pit in a surface of cement material without requiring the installation and removal of temporary forms. Can 10 also forms a liner for the pit receiving the dynamometer. Can 10 separates the functions of a liner for the pit from any rebar desired for reinforcement of the cement material surrounding the pit, thereby avoiding the need for orienting the rebar simultaneously with placing the liner. FIG. 9 illustrates the assembled dynamometer can seated within a cement dynamometer pit.

### EXAMPLE

The following example is included to more clearly demonstrate the overall nature of the invention. This example is exemplary, not restrictive, of the invention. In the example, dynamometer can 10 includes the first (deep) embodiment of motor end module 60 illustrated in FIG. 2.

The floor 24 of main can form module 20 is formed from a sheet of steel about 107 inches long and 19.022 inches wide. Five holes 34 are punched along each side edge along the length of floor 24, with the first and fifth hole 34 each located about 5.5 inches from the end of floor 24 and a distance of about 24 inches separating each hole 34. Two longitudinal bend lines are formed, each about 0.875 inches from the side edge, and the edges are bent upward at an angle of about 90° to form a flange extending upward about 0.875 inches. Thus, the flat, unbent portion of floor 24 is about 17.272 inches wide. Holes 34 are approximately centered in the 0.875-inch width of the flange and disposed horizontally following the bend creating the vertical flange. The two flanges (each having five holes 34) facilitate attachment of first side wall 22 and second side wall 26 to floor 24.

The first side wall 22 and second side wall 26 of main can form module 20 are mirror images. Therefore, a description is provided only of first side wall 22. Side wall 22 is formed from a sheet of steel about 107 inches long. One longitudinal edge of side wall 22 is straight; the other longitudinal edge tapers about one inch along the length. Thus, a first end of side wall 22 is about 19.665 inches wide and the second end of side wall 22 is about 18.665 inches wide. Five holes each having a diameter of about 0.531 inches are punched along each side edge along the length of side wall 22, with the first and fifth hole each located about 5.5 inches from the end of side wall 22 and a distance of about 24 inches separating each hole. Two dynamometer anchor holes 30 are also punched in side wall 22.

Three longitudinal bend lines are formed in side wall 22. The first bend line is about one inch from the non-tapered side edge and the edge is bent upward at an angle of about 90° to form lip 42 having five holes 44 and a width of about one inch. Holes 44 receive bolts 50 used to anchor can 10 to the surrounding cement. The second bend line is about 11.394 inches from the non-tapered side edge and the side wall is bent downward at an angle of about 90° to form ledge 32 (in which anchor holes 30 are located). The third bend line is about 17.29 inches from the non-tapered side edge and the edge is bent upward at an angle of about 90° to form a trapezoidal-shaped section extending upward about 2.375 inches at one end and about 1.375 inches at the other end. The section has five holes located to mate with the five holes in one of the flanges of floor 24 to facilitate attachment (by bolting through the holes) of first side wall 22 to floor 24. The taper provided by the trapezoidal-shaped section gives main can form module 20 a slight (one inch in height along a 107 inch length) downward taper toward motor end module 60 of can 10.

The fourth component of main can form module 20 is end wall 28. End wall 28 is formed from a sheet of steel about 32 inches long and 15.75 inches wide. A longitudinal bend line is formed about one inch from a first edge, and the edge is bent upward at an angle of about 90° to form platform 48 extending upward about one inch. Thus, the flat, unbent portion of end wall 28 is about 14.75 inches wide.

Before the bend is formed, two holes having a diameter of about 0.438 inches are punched along each end of end wall 28. The first of these holes is punched about 1.875 inches below the bend line with the second hole about 8 inches below the first hole. These parallel hole pairs are separated longitudinally by a distance of about 30.334 inches and are used to bolt end wall 28 to angles 124 tacked on first side wall 22 and second side wall 26, respectively. Also before the bend is formed, three holes having a diameter of about 0.438 inches are punched along the edge of end wall 28 opposite the bend. The first of these three holes is centered along the length of end wall 28 and the other two holes are located about 6 inches on either side of the centered hole. These three holes are used to bolt end wall 28 to an angle 122 tacked on floor 24.

Finally, also before the bend is formed, a pair of fork slots 38 are punched in end wall 28. Each slot 38 approximates a rectangle with a length of about 6.259 inches and a width of about 3.250 inches. Fork slots 38 are located on opposite sides of the three holes used to bolt end wall 28 to angle 122 tacked on floor 24 with a distance of about 17.481 inches separating the closest edges of slots 38.

The first of the three components that form motor end module 60 of can 10 is U-shaped center 62. U-shaped center 62 is formed from a sheet of steel about 87.790 inches (56.749 inches for the shallow embodiment) long and 29 inches wide. Two holes 58 are punched, one each adjacent opposing ends and centered along the width of U-shaped center 62. Two horizontal bend lines are formed, each about one inch from an end, and the ends are bent downward at an angle of about 90°0 to form flanges 72 extending downward about one inch. Each flange 72 has a centered hole 58. Holes 58 in flanges 72 receive bolts 50 used to anchor can 10 to the surrounding cement.

Two more horizontal bend lines are formed, each about 28.395 inches (12.875 inches for the shallow embodiment) from one of the first bend lines that are formed about one inch from an end, and the ends are bent upward at an angle of about 90°. The sections between the first and second bends, each having a length of about 28.395 inches (12.875 inches for the shallow embodiment), form the two parallel and opposite side walls 64, 66 of U-shaped center 62. The remaining, central, flat section has a length of about 29 inches and forms bottom 68.

Intermediate wall 80 of motor end module 60 is made from a sheet of steel about 32 inches long and 22.25 inches (6.73 inches for the shallow embodiment) wide. Cutout 82 is cut along one edge, beginning about 7.258 inches from one end and having a length of about 17.484 inches so that cutout 82 is centered along the edge. Three holes having a diameter of about 0.438 inches are punched along the longitudinal edge of cutout 82. The first of these three holes is centered along the length of cutout 82 (and of intermediate wall 80) and the other two holes are located about 6 inches on either side of the centered hole. These three holes are used to bolt intermediate wall 80 to an angle 122 tacked on bottom 68.

Three more holes having a diameter of about 0.438 inches are punched along each end of intermediate wall 80 (these holes may be omitted for the shallow embodiment). The first of these holes is punched about 3.260 inches below the edge of intermediate wall 80 in which cutout 82 is formed. The second hole is about 6 inches below the first hole and the third hole is about 6 inches below the second hole. These parallel sets of three holes are separated longitudinally by a distance of about 30.334 inches and are used to bolt intermediate wall 80 to angles 121 tacked on opposite side walls 64 and 66, respectively, of U-shaped center 62.

A final set of three holes having a diameter of about 0.438 inches are punched along the edge of intermediate wall 80 opposite the edge of intermediate wall 80 in which cutout 82 is formed (these holes coincide with the three holes punched along the longitudinal edge of cutout 82 for the shallow embodiment). The first of these three holes is centered along the length of intermediate wall 80 and the other two holes are located about 6 inches on either side of the centered hole. These three holes are used to bolt intermediate wall 80 to angles 122 tacked on bottom 68. There are a total of twelve holes punched in intermediate wall 80 (only three holes total are punched in intermediate wall 80 for the shallow embodiment).

Finally, a pair of fork slots 88 are punched in intermediate wall 80. Each slot 88 approximates a rectangle with a length of about 6.259 inches and a width of about 3.250 inches. Fork slots 88 are located on opposite sides of the three holes used to bolt intermediate wall 80 to angle 122 tacked on bottom 68 with a distance of about 17.481 inches separating the closest edges of slots 88.

The third component of motor end module 60 of can 10 is access wall 70. Access wall 70 is formed from a sheet of steel about 32 inches long and 33.75 inches (18.23 inches for the shallow embodiment) wide. A longitudinal bend line is formed about one inch from a first edge, and the edge is bent upward at an angle of about 90° to form shoulder 74 extending upward about one inch. Thus, the flat, unbent portion of access wall 70 is about 32.75 inches wide (17.23 inches for the shallow embodiment).

Before the bend is formed, five holes having a diameter of about 0.438 inches are punched along each end of access wall 70 (two holes are punched for the shallow embodiment). The first of these holes is punched about 1.875 inches below the bend line with the second hole about 8 inches below the first hole (these are the only holes punched for the shallow embodiment). The third hole is about 3.885 inches below the second hole, the fourth hole is about 6 inches below the third hole, and the fifth and final hole is about 6 inches below the fourth hole. These parallel hole pairs are separated longitudinally by a distance of about 30.334 inches and are used to bolt access wall 70 to angles 121 tacked on opposite side walls 64 and 66, respectively, of U-shaped center 62. Also before the bend is formed, three holes having a diameter of about 0.438 inches are punched along the edge of access wall 70 opposite the bend. The first of these three holes is centered along the length of access wall 70 and the other two holes are located about 6 inches on either side of the centered hole. These three holes are used to bolt access wall 70 to an angle 122 tacked on bottom 68.

Also before the bend is formed, a pair of fork slots 78 are punched in access wall 70. Each slot 78 approximates a rectangle with a length of about 6.259 inches and a width of about 3.250 inches. Fork slots 78 are located on opposite sides of the three holes used to bolt access wall 70 to an angle 122 tacked on bottom 68 with a distance of about 17.481 inches separating the closest edges of slots 78.

Finally, also before the bend is formed, several openings are punched in access wall 70. These openings include smallest opening 90 having a diameter of about one inch, largest opening 92 having a diameter of about 6.5 inches, intermediate opening 94 having a diameter of about 2.5 inches, and an additional opening 96 having a diameter of about one inch. The openings allow passage of various components to facilitate operation of the dynamometer.

Four types of angles are provided. Each type is formed from a strip of steel and provided with a 90° bend to form two legs. One leg has two or more holes and the other leg remains free of holes. The hole-free leg is tacked (e.g., welded) to one of the components of can 10. The most important differences among the four types of angles are their dimensions and the number of holes provided in one of their legs.

Four of the first type of angles 121 are provided. Angles 121 have a length of about 28.5 inches and a width of about 1.791 inches. A bend line is formed along the center of angles 121, about 0.895 inches from either edge, so that angles 121 form two equal legs when bent along the bend line at about 90°. Before the bend is formed, five holes having a diameter of about 0.531 inches are punched so that their centers are approximately 0.438 inches from one edge of angles 121. The first of these holes is punched about 1.875 inches from one end with the second hole about 8 inches from the first hole. The third hole is about 3.885 inches from the second hole, the fourth hole is about 6 inches from the third hole, and the fifth and final hole is about 6 inches from the fourth hole (and about 2.740 inches from the opposite end). Inserts can be provided in each hole for receiving corresponding bolts.

First angles 121 are tacked to opposite side walls 64, 66 of U-shaped center 62. One angle 121 is positioned along the first edge of side wall 64, extending upward from bottom 68 to the open top of U-shaped center 62. Another angle 121 is similarly positioned along the second edge of side wall 64. The third and fourth angles 121 are positioned in corresponding locations along the edges of side wall 66. Thus, two angles 121 are used to attach (i.e., bolt) access wall 70 to U-shaped center 62 and two angles 121 are used to attach intermediate wall 80 (via three bottom holes) and main can form module 20 (via two top holes) to U-shaped center 62.

Four of the second type of angles 122 are provided. Angles 122 have a length of about 17.481 inches and a width of about 1.791 inches. A bend line is formed along the center of angles 122, about 0.895 inches from either edge, so that angles 122 form two equal legs when bent along the bend line at about 90°. Before the bend is formed, three holes having a diameter of about 0.531 inches are punched so that their centers are approximately 0.438 inches from one edge of angles 122. The first of these holes is punched about 2.740 inches from one end with the second hole about 6 inches from the first hole. The third hole is about 6 inches from the second hole (and about 2.740 inches from the opposite end). Inserts can be provided in each hole for receiving corresponding bolts.

Two of second angles 122 are tacked to opposite ends of bottom 68 of U-shaped center 62. One angle 122 is positioned along the first end of bottom 68, so that it extends between fork slots 78 of access wall 70 when access wall 70 is attached to U-shaped center 62 using that angle. Another angle 122 is positioned along the opposite end of bottom 68, so that it extends between fork slots 88 of intermediate wall 80 when intermediate wall 80 is attached to U-shaped center 62 using that angle.

The two remaining second angles 122 are tack welded to opposite ends of floor 24 of main can form module 20. One angle 122 is positioned along the first end of floor 24, so that it extends along the length of and just below cutout 82 of intermediate wall 80 when intermediate wall 80 is attached to floor 24 using that angle. The fourth and final angle 122 is positioned along the opposite end of floor 24, so that it extends between fork slots 38 of end wall 28 when end wall 28 is attached to floor 24 using that angle.

Two of the third type of angles 123 are provided. Angles 123 have a length of about 11.750 inches and a width of about 1.791 inches. A bend line is formed along the center of angles 123, about 0.895 inches from either edge, so that angles 123 form two equal legs when bent along the bend line at about 90°. Before the bend is formed, two holes having a diameter of about 0.375 inches are punched so that their centers are approximately 0.438 inches from one edge of angles 123. Each of the two holes is punched about 1.875 inches from one end with a distance of about 8 inches between the two holes.

One third angle 123 is tacked to first side wall 22 and the other third angle 123 is tacked to second side wall 26 of main can form module 20. Third angles 123 are positioned adjacent the open end of main can form module 20, extending vertically between ledges 32, 36 and lips 42, 46 of first side wall 22 and second side wall 26, respectively. The two holes of angles 123 are aligned with the top two (of five) holes in the first angles 121 tacked to opposite side walls 64, 66 of U-shaped center 62 of motor end module 60 adjacent intermediate wall 80. Bolts are inserted through the aligned holes in angles 121, 123 to attach main can form module 20 to motor end module 60.

Two of the fourth type of angles 124 are provided. Angles 124 are identical to angles 123, including two holes having a diameter of about 0.531 inches. Inserts can be provided in each hole of angles 124 to receive corresponding bolts. One of the two angles 124 is tacked to the portion of first side wall 22 of main can form module 20 extending between ledge 32 and the open top of first side wall 22. The other of the two angles 124 is tacked to the portion of second side wall 26 of main can form module 20 extending between ledge 36 and the open top of second side wall 26. Both angles 124 are located adjacent the ends of side walls 22, 26 where end wall 28 will be attached to side walls 22, 26 so that angles 124 can be used to attach (i.e., bolt) those components together.

Main can form module 20 is identical regardless of whether the deep or shallow embodiment of motor end module 60 is used. Therefore, all of the angles tacked to main can form module 20 (namely angles 122, 123, and 124) are the same for either embodiment. In addition, the two second angles 122 tacked to opposite ends of bottom 68 of U-shaped center 62 of motor end module 60 are the same regardless of the embodiment used. The four angles 121 (having five holes) used on motor end module 60 for the deep embodiment described above, however, are replaced with four more angles 124 having two holes for the shallow embodiment. Regardless of the embodiment, a total of twelve angles are used to assemble the components.

Optionally used in the shallow embodiment, steps 84 are formed from a sheet of steel about 28.875 inches long and 10.5 inches wide. A pair of longitudinal bend lines are formed about 2.375 inches from each edge, and the edges are bent upward at an angle of about 90° to give steps 84 a U-shape. Thus, the flat, unbent portion of steps 84 is about 5.75 inches wide.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention.

What is claimed:

1. A modular dynamometer can assembly defining an interior region sized to house and support a dynamometer, the can assembly comprising:
a main can form module adapted for prefabrication at a first location and transportation in a disassembled state to a second installation location; and
a separate and discrete motor end module adapted for prefabrication at the first location and transportation in a disassembled state to the second installation location where the main can form module and the motor end module are assembled and engaged, forming the modular dynamometer can.

2. The modular dynamometer can assembly according to claim 1 wherein the main can form module is assembled from at least the following individual components:
(a) a first side wall,
(b) a second side wall disposed opposite the first side wall,
(c) a floor located between the first and second side walls, and
(d) an end wall engaging the first side wall, the second side wall, and the floor, closing one end of the main can form module when the main can form module is assembled.

3. The modular dynamometer can assembly according to claim 2 wherein the floor has a ledge adapted to support the dynamometer with anchor holes in the ledge accommodating projections on the dynamometer.

4. The modular dynamometer can assembly according to claim 2 wherein the end wall extends below the floor and has a pair of fork slots adapted to engage the prongs of a fork lift.

5. The modular dynamometer can assembly according to claim 2 further comprising angles on the first side wall, the second side wall, and the floor connecting the components and reinforcing the stiffness and rigidity of the can when assembled.

6. The modular dynamometer can assembly according to claim 2 further comprising a plurality of bolts and wherein the side walls have lips with a plurality of holes receiving the bolts.

7. The modular dynamometer can assembly according to claim 6 wherein the end wall has a platform disposed in substantially the same horizontal plane as the lips of the side walls creating a neck around the upper periphery of the main can form module when that module is assembled.

8. The modular dynamometer can assembly according to claim 1 wherein the motor end module is assembled from at least the following individual components:
(a) a U-shaped center including two opposing side walls and a bottom,
(b) an access wall closing one end of the center when the motor end module is assembled, and
(c) an intermediate wall closing the second end of the center when the motor end module is assembled.

9. The modular dynamometer can assembly according to claim 8 wherein at least one of the access wall and the intermediate wall extends below the bottom and has a pair of fork slots adapted to engage the prongs of a fork lift.

10. The modular dynamometer can assembly according to claim 8 further comprising angles on the U-shaped center connecting the components and reinforcing the stiffness and rigidity of the can when assembled.

11. The modular dynamometer can assembly according to claim 8 further comprising a plurality of bolts and wherein the side walls of the U-shaped center have flanges with at least one hole receiving a bolt.

12. The modular dynamometer can assembly according to claim 11 wherein the access wall has a shoulder disposed in substantially the same horizontal plane as the flanges of the side walls of the U-shaped center creating a neck around the upper periphery of the motor end module when that module is assembled.

13. The modular dynamometer can assembly according to claim 8 wherein the access wall has at least one opening adapted to receive conduits serving the dynamometer.

14. The modular dynamometer can assembly according to claim 8 wherein the intermediate wall of the motor end module has a cutout engaging the main can form module when the modules are assembled.

15. The modular dynamometer can assembly according to claim 1 wherein the can is steel devoid of any rebar attached to the can.

16. The modular dynamometer can assembly according to claim 1 wherein the motor end module defines a sump region facilitating removal of any liquids that collect in the can and the main can form module slopes toward the motor end module enabling liquids to migrate toward the motor end module.

17. The modular dynamometer can assembly according to claim 1 wherein the can is adapted to line a dynamometer pit formed in the surface of cement material.

18. A modular dynamometer can assembly defining an interior region sized to house and support a dynamometer, the can comprising:
a main can form module adapted for prefabrication at a first location and transportation in a disassembled state to a second installation location where it is assembled from at least the following individual components:
(a) a first side wall,
(b) a second side wall disposed opposite the first side wall,
(c) a floor located between the first and second side walls, and
(d) an end wall engaging the first side wall, the second side wall, and the floor, closing one end of the main can form module when the main can form module is assembled; and
a separate motor end module adapted for prefabrication at the first location and transportation in a disassembled state to the second installation location where it is assembled from at least the following individual components:
(a) a U-shaped center including two opposing side walls and a bottom,
(b) an access wall closing one end of the center when the motor end module is assembled, and
(c) an intermediate wall closing the second end of the center when the motor end module is assembled;
the motor end module engaging the main can form module upon assembly of the modular dynamometer can.

19. The modular dynamometer can assembly according to claim 18 wherein the floor has a ledge adapted to support the dynamometer with anchor holes in the ledge accommodating projections on the dynamometer.

20. The modular dynamometer can assembly according to claim 18 wherein the end wall extends below the floor and has a pair of fork slots adapted to engage the prongs of a fork lift and wherein at least one of the access wall and the intermediate wall extends below the bottom and has a pair of fork slots adapted to engage the prongs of a fork lift.

21. The modular dynamometer can assembly according to claim 18 further comprising angles on the first side wall, the second side wall, the floor, and the U-shaped center connecting the components and reinforcing the stiffness and rigidity of the can when assembled.

22. The modular dynamometer can assembly according to claim 18 further comprising a plurality of bolts and wherein the first and second side walls have lips with a plurality of holes receiving the bolts and the opposing side walls of the U-shaped center have flanges with at least one hole receiving a bolt.

23. The modular dynamometer can assembly according to claim 22 wherein the end wall has a platform and the access wall has a shoulder, the platform, shoulder, lips, and flanges all disposed in substantially the same horizontal plane creating a neck around the upper periphery of the can when the modules are assembled.

24. The modular dynamometer can assembly according to claim 23 wherein the neck has a width of at least one inch and is adapted to engage the edge of a dynamometer pit seating the assembled can in that pit.

25. The modular dynamometer can assembly according to claim 18 wherein the access wall has at least one opening adapted to receive conduits serving the dynamometer.

26. The modular dynamometer can assembly according to claim 18 wherein the intermediate wall of the motor end module has a cutout engaging the main can form module when the modules are assembled.

27. The modular dynamometer can assembly according to claim 18 wherein the can is steel devoid of any rebar attached to the can.

28. The modular dynamometer can assembly according to claim 18 wherein the motor end module defines a sump region facilitating removal of any liquids that collect in the can and the main can form module slopes toward the motor end module enabling liquids to migrate toward the motor end module.

29. The modular dynamometer can assembly according to claim 18 wherein the can is adapted to line a dynamometer pit formed in the surface of cement material.

30. A modular steel dynamometer can assembly defining an interior region sized to house and support a dynamometer, the can comprising:
a main can form module adapted for prefabrication at a first location and transportation in a disassembled state to a second installation location where it is assembled from at least the following individual components:
(a) a first side wall having a lip with a plurality of holes,
(b) a second side wall disposed opposite the first side wall and having a lip with a plurality of holes,
(c) a sloped floor located between the first and second side walls and having a ledge adapted to support the dynamometer with anchor holes in the ledge accommodating projections on the dynamometer, and
(d) an end wall engaging the first side wall, the second side wall, and the floor, closing one end of the main can form module when the main can form module is assembled, extending below the floor, including a platform, and having a pair of fork slots adapted to engage the prongs of a fork lift;
a separate motor end module defining a sump region facilitating removal of any liquids that collect in the can and adapted for prefabrication at the first location and transportation in a disassembled state to the second installation location where the motor end module is assembled from at least the following individual components:
(a) a U-shaped center including two opposing side walls and a bottom, the opposing side walls each having a flange with at least one hole,
(b) an access wall closing one end of the center when the motor end module is assembled, extending below the bottom, including a shoulder, and having at least one opening adapted to receive conduits serving the dynamometer and a pair of fork slots adapted to engage the prongs of a fork lift, and
(c) an intermediate wall closing the second end of the center when the motor end module is assembled and having a cutout engaging the main can form module when the main can form module and the motor end module are assembled,
the motor end module engaging the main can form module upon assembly of the modular dynamometer can;
angles on the first side wall, the second side wall, the floor, and the U-shaped center connecting the components and reinforcing the stiffness and rigidity of the can when assembled; and
a plurality of bolts received in the holes of the lips of the first and second side walls and in the holes of the flanges of the opposing side walls;
wherein the platform of the end wall, the shoulder of the access wall, the lips of the first and second side walls, and the flanges of the opposing side walls are all disposed in substantially the same horizontal plane creating a neck around the upper periphery of the can when the modules are assembled.
